(19) United States
(12) Patent Application Publication
(10) Pub. No.: US 2001/0011262 A1
(43) Pub. Date: Aug. 2, 2001

(54) PHOTO KIOSK FOR TRANSMITTING A PHOTOGRAPHIC IMAGE

(76) Inventors: TIMOTHY HOYT, MIAMI, FL (US); DAVID FOSTER, MIAMI, FL (US)

Correspondence Address: TOWNSEND AND TOWNSEND AND CREW, TWO EMBARCADERO CENTER, EIGHTH FLOOR, SAN FRANCISCO, CA, 941113834

(21) Appl. No.: 09/089,272

(22) Filed: Jun. 2, 1998

Related U.S. Application Data
(60) Provisional application No. 60/048,539, filed on Jun. 3, 1997.

(51) Int. Cl. G06F 7/00

(52) U.S. Cl. 707/1; 396/2; 709/250

(57) ABSTRACT

A public booth for transferring an image of a user over a wide area network of computers. The booth includes, among other features, an image capturing device (e.g., CCD camera), which is coupled to the housing. The image capturing device is adapted or directed toward a user to capture an image of the user. The apparatus also includes a processing device (e.g., computer, microprocessor), which is coupled to the image capturing device. In a specific embodiment, the processing device converts the captured image into a plurality of signals, e.g., digital or analog. The apparatus further includes a transmission device (e.g., modem, transmitter), which is coupled to the processing device. The transmission device is adapted to transmit the plurality of signals. Alternatively, the transmission device may receive a plurality of signals. A wide area network of computers is coupled to the transmission device to receive the plurality of signals. At least one of the computers displays the image of the user on, for example, a web site or at a user location.

### CROSS REFERENCE TO RELATED APPLICATIONS

The following three commonly-owned co-pending applications, including this one, are being filed concurrently and the other two are hereby incorporated by reference in their entirety for all purposes:

1. U.S. patent application Ser. No.______, Timothy Hoyt and David Foster, entitled, “Internet Photo Booth,” (Attorney Docket Number 18720-000210);

2. U.S. patent application Ser. No.______, Timothy Hoyt and David Foster, entitled, “Method For Internet Photo Booth,” (Attorney Docket Number 18720-000220); and

3. U.S. patent application Ser. No.______, Timothy Hoyt and David Foster, entitled, “Internet Photo Booth System,” (Attorney Docket Number 18720-000230).

This application claims priority to Provisional Application Ser. No. 60/048,539, filed Jun. 3, 1997 (Attorney Docket No. 18720-000200), in the name of the present assignee, and hereby incorporated by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to publicly located photo kiosks or booths. More particularly, the present invention provides an image capturing device in a kiosk or photo booth that captures digital images of a user in the form of video and/or still pictures. Merely by way of example, the present invention can be applied to technologies such as telephone systems, wide area networks, Internet, and other communication means.

Game, amusement parks, shopping malls, and alike, have commonly distributed photo kiosks for users to take photographic images or Polaroid™ pictures of themselves for entertainment purposes. Various types of these photo kiosks have been used. As merely an example, conventional photo kiosks were generally configured in the form of booths or stalls. The booths were either totally or partially enclosed, where users or subjects could pose against a standard background fixed in the enclosed area while the users take a photograph of themselves. Accordingly, users or subjects pose in front of a fixed panoramic view or background of the “Grand Canyon” while in Arizona. Alternatively, the users pose in front of the Magic Kingdom™ castle at Disneyland™ park. In other cases, college or high school students have amused themselves by cramming a large number, often four or five, of themselves into the booth without any specific background for a group picture. After taking the photograph, the photo booth processes the photograph and delivers a finished print to the users. Typically, the finished product was in the form of a photographic image or print or, in some cases, additional prints of the same image could be obtained from the photo booth at an additional cost to the users.

Other types of photo booths having multiple or selectable backgrounds (or foregrounds) were also used or proposed. These photo booths or kiosks included types in which the enclosed or partially enclosed area has been eliminated and in which the user inputs a selected background image. Such photo kiosks, however, have not been user friendly in the sense of providing an effective visually interactive interface with the user to enable consistently acceptable results under the full control of the user and being able to attract users with effective visual displays. In addition, the finished product delivered to the user was in the form of a single image or in the form of additional and separate prints of the same image. Accordingly, the finished product has limited the use and appeal of such photo booths.

Most recently, sticker photo booths have been used. A user of this booth desiring a photograph poses directly in front of the kiosk to have a picture taken against a selected computer generated background and in which a multiple image format in the form of “stickers” on a single sheet is delivered to the user from a frozen image selected by the user. These photo booths have been quite popular in countries such as Japan. Sticker photo booths, however, have numerous limitations. These photo booths, in most cases, only produce stickers and cannot produce single photographic images. Additionally, sticker photo booths generally have been popular with the “younger” generation and have not been accepted uniformly with the “older” crowd. Although the above photo booths have had limited success, they simply cannot remain popular without improvements. Additionally, the above photo booths are limited in the type of output that is derived. In some cases, the output is a photographic image in the form of a Polaroid™ print. Furthermore, some conventional photo kiosks have generally penetrated the entertainment market and have not generally been accepted in commercial settings.

From the above, it is seen that an improved photo kiosk for entertainment purposes or communication purposes is highly desirable.

### SUMMARY OF THE PRESENT INVENTION

According to the present invention, a technique, including a system and method, for capturing and transmitting images is provided. In an exemplary embodiment, the present invention provides a novel kiosk or photo booth at a public location. The kiosk can provide numerous functions such as capturing images of people, as well as other beings. These images are then packaged to be transferred to one of a plurality of output devices, e.g., Internet, monitor, display, and print.

In a specific embodiment, the present invention provides a novel kiosk apparatus. The kiosk includes, among other elements, a housing which can be either a fully or partially enclosed structure, as well as other structural configurations. An image capturing device (e.g., charged coupled device (“CCD”) camera) is coupled to the housing. The image capturing device is adapted or directed toward a user to capture an image of the user. In preferred embodiments, the image is captured in front of or behind one of many “scenes” or “backgrounds.” The apparatus also includes a processing device (e.g., computer, microprocessor), which is coupled to the image capturing device. In a specific embodiment, the processing device converts the captured image into a plurality of signals, e.g., digital or analog. The apparatus further includes a transmission device (e.g., modem, transmitter), which is coupled to the processing device. The transmission device is adapted to transmit the plurality of signals. Alternatively, the transmission device may receive a plurality of signals. A wide area network of computers is coupled to the transmission device to receive the plurality of signals. At least one of the computers displays the image of the user on, for example, a web site or at a selected location.

In an alternative embodiment, the present invention provides a public booth for transferring and/or receiving an image of a user over a wide area network of computers. The booth includes, among other features, an image capturing device (e.g., CCD camera), which is coupled to a housing. The image capturing device is adapted or directed toward a user to capture an image of the user. The apparatus also includes a processing device (e.g., computer, microprocessor), which is coupled to the image capturing device. In a specific embodiment, the processing device converts the captured image into a plurality of signals, e.g., digital or analog. The apparatus further includes a transmission device (e.g., modem, transmitter), which is coupled to the processing device. The transmission device is adapted to transmit (e.g., hardware or wireless) the plurality of signals, which represent the captured image. Alternatively, the transmission device may receive a plurality of signals. A wide area network of computers is coupled to the transmission device to receive the plurality of signals from the transmission device. At least one of the computers displays the image of the user on, for example, a web site or at a selected location via e-mail or other routing techniques.

In an alternative embodiment, the present invention provides a booth for capturing a photographic quality image of a user. The booth includes, among other elements, a housing which can be either a fully or partially enclosed structure. An image capturing device (e.g., CCD camera) is coupled to the housing. The image capturing device is adapted or directed toward a user to capture an image of the user. The booth also includes a processing device (e.g., computer, microprocessor), which is coupled to the image capturing device. In a specific embodiment, the processing device converts the captured image into a plurality of signals, e.g., digital or analog. The booth further includes a transmission device (e.g., modem, transmitter), which is coupled to the processing device. The transmission device is adapted to transmit the plurality of signals. Alternatively, the transmission device may receive a plurality of signals. A wide area network of computers is coupled to the transmission device to receive the plurality of signals. At least one of the computers displays the image of the user on, for example, a web site or at a selected location. In a preferred embodiment, the booth has at least two display devices, including a first display device for outputting the image from the user, and a second display device for attracting the user to the booth using one or more graphical images. Alternatively, the two display devices can be the same display device, which can be viewed by the user as well as any potential users.

Numerous benefits or advantages are achieved over conventional devices using the present invention. In one aspect, the present invention provides a photo kiosk or kiosk that is easily useable and universally accessible. The photo kiosk can be used by members of the general public who have substantially no knowledge of or access to computers or digital photography equipment. That is, it enables even the most non-technologically adept person to digitally capture and manipulate professional-quality images and to create their own pages on, for example, the World Wide Web. Additionally, the present invention allows users to launch images of themselves onto a web page, thus enabling them to distribute their creations instantly and worldwide. The present photo booth also has a capability to capture and distribute video images (e.g., stills and moving pictures) in one or more embodiments. Also, it is designed for group use, i.e., it seats 2-3 people comfortably. These advantages can exist alone or together in any combination of one or more embodiments of the present invention. These and other advantages, however, are more fully described throughout the present specification, and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 shows a simplified frontal view of a booth according to an embodiment of the present invention;

FIG. 2 is a simplified interior diagram of a booth according to an embodiment of the present invention;

FIG. 3 shows a simplified side view of a booth with a door and hardware components revealed according to an embodiment of the present invention;

FIG. 4 is a simplified flow diagram of a general method according to an embodiment of the present invention;

FIG. 4A shows a simplified flow diagram (entitled “Attract Loop”) that plays a video montage;

FIG. 4B shows a simplified flow diagram (entitled “Theme Select”) that provides one of many backgrounds for users to compose their image with;

FIG. 4C shows a simplified flow diagram (entitled “Photo Capture”) that captures a user's image;

FIG. 4D shows a simplified flow diagram (entitled “Process Photo”) which converts a captured image into transferrable information;

FIG. 4E shows a simplified flow diagram (entitled “Enter Title”) which enables a user to create a title to add to a picture;

FIG. 4F shows a simplified flow diagram (entitled “Print Photo”) which creates a web address and transfers the image file to a web page or selected address;

FIG. 4G shows a simplified flow diagram (entitled “Upload Files”) which allows a picture or image to be uploaded onto a web page or selected address

### DESCRIPTION OF SPECIFIC EMBODIMENTS

I. Present System Hardware

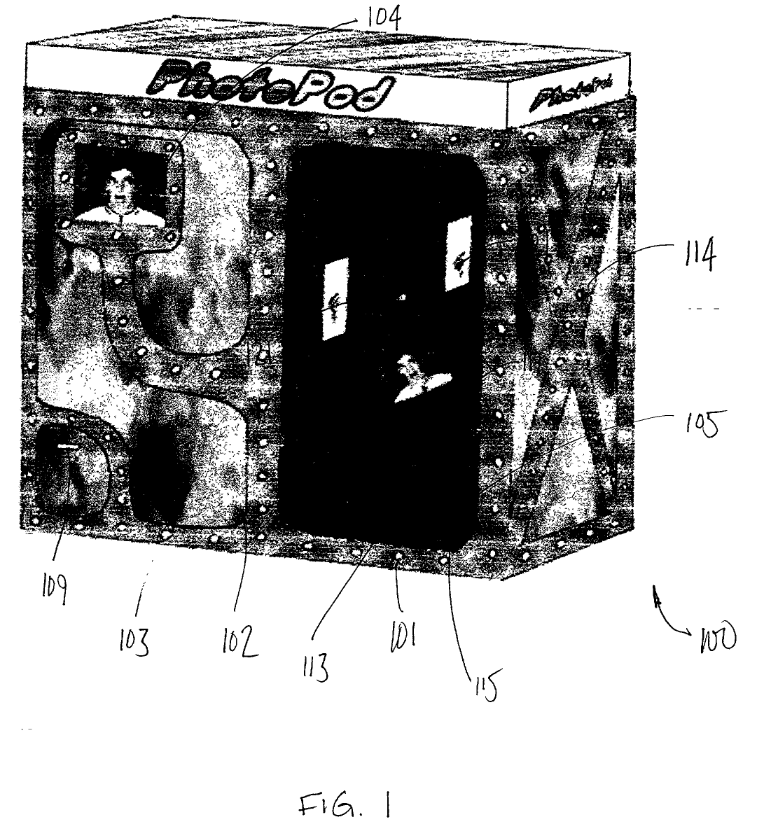

FIG. 1 shows a simplified outside view diagram a booth or kiosk 100 according to an embodiment of the present invention. The diagram is merely an illustration and should not limit the scope of the claims herein. One of ordinary skill in the art would recognize other variations, modifications, and alternatives. The booth includes a housing 101 or any suitable enclosure for holding various hardware and software elements, as well as a user(s). The enclosure is often made of a durable material that can withstand one or more human users and can also withstand a variety of environmental conditions or weather such as heat, moisture, and other types of weather or the like. The enclosure is often made of a material such as a combination of wood, metal, and synthetic materials such as plastic or the like. In some applications, the enclosure can also be made of a fiberglass type material. The enclosure is also capable of housing a human user or numerous human users that can use and even abuse the present booth according to aspects of the present invention.

The enclosure or booth includes a variety of element such as exterior region 103 and opening 105, which allows one or more users to enter or exit the booth. The opening is also large enough for handicapped users and alike. The external region is generally capable of being placed or installed easily at numerous locations without substantial fit-up costs. In most embodiments, the external region can be installed using conventional power and/or a telephone network line or lines. The exterior region has sides 102, including a backside 114. The external region has an external monitor 107 that displays or outputs a video and/or audio “teaser.” The teaser is generally output that attracts people to use the booth. The booth also has a receptacle 109 for output, e.g., one or more photographs, stickers, or hard copies. In most embodiments, the output appears at the receptacle within three minutes or less, or two minutes or less, or one minute or less of capturing an image of the user or users in the booth.

In a specific embodiment, a user(s) enters an interior region 113 of the booth through the opening and performs one or more functions according to embodiments of the present invention. That is, the user sits or even stands on a bench 115, which can be wide and even upholstered. The bench faces a screen 117, which can be a display as well as a display in combination with a user interface, e.g., touch screen. The interior region also includes a vending card reader 119 (or bill, coin, or token receptacle), and lights 121 (e.g., one or two or more) which flash at various times including a time when a picture is taken of the user. The interior region also includes audio output devices such as, for example, a stereo sub-woofer 120, and stereo speakers 122, which can be implemented behind the user. The interior region also includes a camera 123, which captures images of the user or users. The camera 123 is often covered in a clear plastic or glass material for durability. The interior region also includes an area for electronic or computer hardware such as a central processing unit, which will be used to oversee the various operations in the booth.

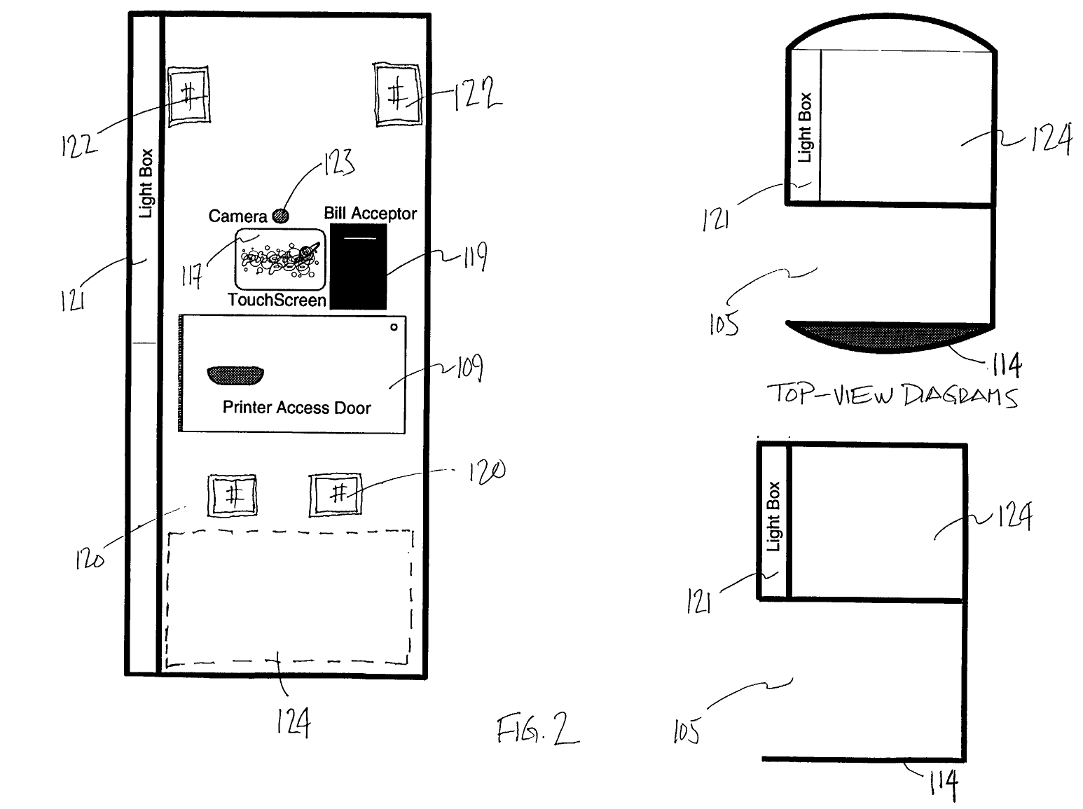

FIG. 2 is a simplified interior diagram of a booth according to an embodiment of the present invention. The diagram is merely an illustration and should not limit the scope of the claims herein. Simplified top-view diagrams are also shown. One of ordinary skill in the art would recognize other variations, modifications, and alternatives. The interior diagram includes a variety of elements such as the display or display in combination with a touch screen. The interior region also includes vending card reader 119, and lights 121 (e.g., one or two or more) which flash at various times including a time when a picture is taken of the user. The interior region also includes audio output devices such as, for example, a stereo sub-woofer 120, and stereo speakers 122, which can be implemented behind the user. The interior region also includes camera 123, which captures images of the user or users. The camera 123 is often covered in a clear plastic or glass material for durability. The interior region also includes an area 124 for computer or electronic hardware, such as the central processing unit.

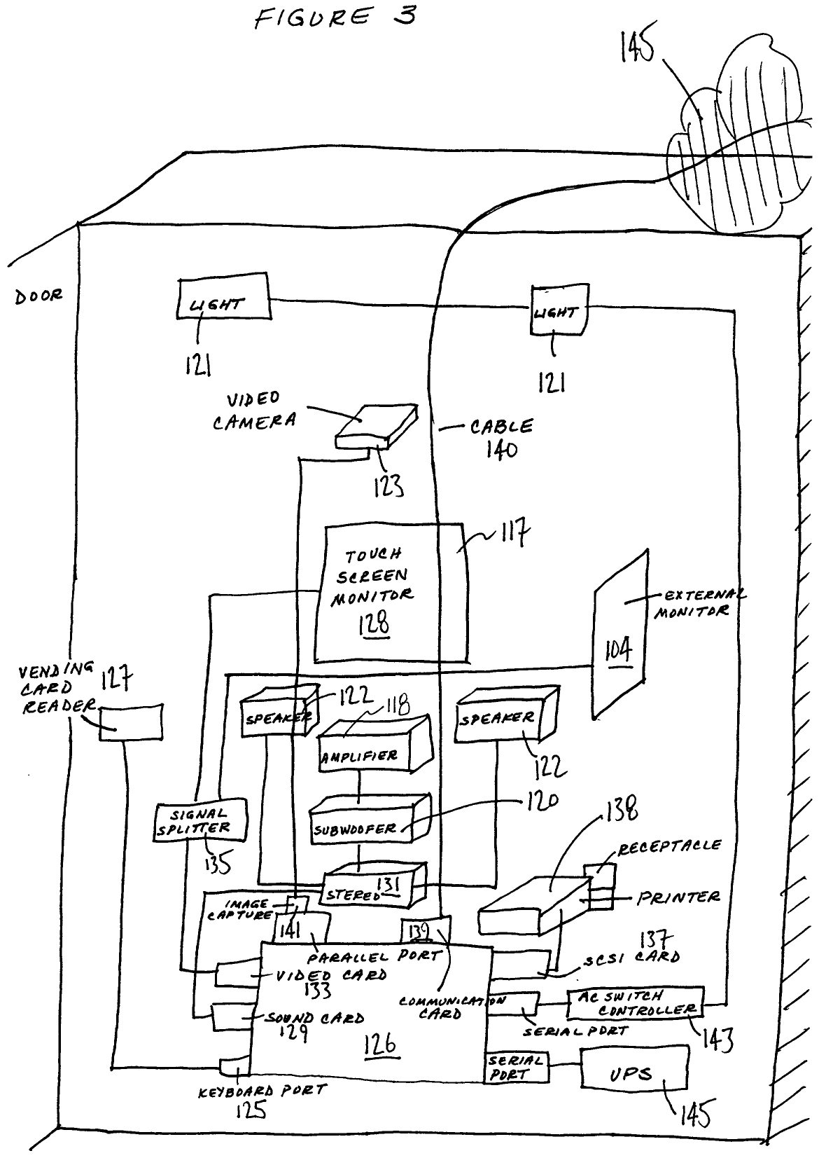

FIG. 3 shows a simplified side-view diagram of a booth according to an embodiment of the present invention. The side-view diagram illustrates a variety of functional blocks or elements which can be in the form of hardware or software or a combination of hardware and software. The side-view diagram is merely an illustration and should not limit the scope of the claims herein. One of ordinary skill in the art would recognize other variations, modifications, and alternatives. The booth can include a variety of elements such as a door that is opened. As shown, the elements are partly revealed. The booth includes a computer 126 or any type of central processing unit (i.e., CPU) or the like. The computer can also include any suitable microprocessor based unit such as an IBM PC-compatible system that has a microprocessor unit such as a Pentium™ chip manufactured by Intel Corporation of Santa Clara, Calif., or equivalent. The CPU is coupled to a variety of other elements such as a keyboard port 125, which is coupled or connect to a vending card reader 127 or other bill, coin, or token receptacle.

The CPU also connects to or is coupled to other input devices. The input devices can include command input devices suitable for accepting commands, for example, a touch screen 128, a writing tablet, a computer mouse, a joystick, a trackball, push-button(s) and/or knobs, a keypad, a keyboard, a speech-recognition or keyword spotting system (e.g., including microphone), an image or motion detection or recognition system (e.g., a text-, handwriting-, face-, sign-language, etc.-recognition system, etc.), and others. In the specific embodiment, the input device includes a touch screen 128 implemented on the display itself The CPU is also coupled to an audio output device such as a sound card 129, which is coupled or connected to a stereo receiver 131, which is coupled or connected to stereo speakers 122 and the stereo sub-woofer 120. The audio output device can also be coupled to one or more speakers, which can include sub-woofers and sub-sonic speakers, audio synthesizers, buzzers, bells, and others audio output means, depending on the particular configuration chosen. An amplifier 118 coupled to the stereo can also be included. The CPU is also coupled or connected to a video display card 133, which is coupled to or connected to a signal splitter 135, which is coupled to or connect to touch screen monitor and external monitor 104. The monitor or display can be any suitable computer-type display, for example, a cathode ray tube video display, a flat panel display (e.g., a liquid-crystal display), and others, depending on the particular configuration chosen. The display can also include or be supplemented with lights, indicator lights, strobe lights, LEDs, and the like. In a specific embodiment of the invention, the visual display is a computer-type display. Other types of output devices can include, among others, smoke emitters, smell emitters, seat mover/shakers, liquid or water spray devices, vibrators, wind machines, and the like.

The CPU also couples to or connects to a standard interface card as a SCSI card 137. SCSI card connects to or couples to an output device for hard copies such as, for example, a dye sublimation printer 138, whose output goes into the receptacle for photographs. In preferred embodiments, the CPU connects to or is coupled to a communication device 139 or network interface card, which connects to a transmitting and/or receiving device. The transmitting and/or receiving device can include either wireless or wired elements such as cable or a telephone line. Alternatively, the CPU connects to or is coupled through a modem and a phone line or cable to a wide area network of computers. As merely an example, the device can be a cable 140 which runs out of an upper region of the booth and plugs into a computer network or phone line provided by a venue or selected geographic location, e.g., theme park, mall, golf course, hotel, motel, store, business, gas station, airport, festivals, trade shows, cruise ships, train terminals, arcades, bars, clubs, and organizational meetings such as reunions and the like.

The CPU also couples to or connects to an image processing device 141. The image processing device can be, for example, a Snappy image capture device made by Play Inc. This image processing device couples to or connects to video camera 123, e.g., CCD camera. The camera is directed to or points to the user or users. The CPU also connects to or is coupled through a serial port to a switch controller 143, which can be an AC switch controller or the like. The switch couples through a serial port, parallel port, USB port, or other computer interface to a switch controller, which can selectively turned off and on the lights. The CPU also connects to or couples through a serial port, parallel port, USB port, or other computer interface to a switch controller to a UPS 145 (i.e., Uninterrupted Power Supply). An AC power supply (e.g., 120 Volt/60 Hertz) of the CPU also connects to or is coupled to the UPS.

The CPU also uses or is connected to attendant support chips, buses, and interfaces. The CPU also runs under the direction of software at least partially residing during run-time in a random access memory (RAM). The software also may reside in nonvolatile storage, such as a hard disk, flash memory, CD-ROM, DVD, removable disk memory, floppy disk, flash cards, and others. The storage device or devices also includes content for describing specific themes or experiences. These memory devices store can store the software features described throughout the present specification, as well as others.

The network interface card provides access to an external network 145, such as the Internet, using network protocols, for example TCP/IP, and others, depending on the particular network type. Network interfaces, as well as details for connecting with specific networks, such as local area networks, wide area networks, intranets, extranets, and the Internet, are generally conventional, but can be tailored for the specific application. A network server will receive captured data from the booth and the like at a remote location, for example.

Although the above description has generally been described in terms of hardware, the functionality of the above can be replaced by a combination of hardware and/or software. The hardware can also be further separated into other hardware and/or software elements. Additionally, the hardware can also be combined or integrated together as a single element, a module, or integrated circuit chip. Accordingly, the above descriptions should not limit the scope of the claims herein. One of ordinary skill in the art would recognize other variations, modifications, and alternatives.

Additionally, although the above diagrams show a booth that is totally enclosed, a variety of other types of booths can be used. As merely an example, the booth can be partially enclosed and does not include a bench, for example. Additionally, the backside of the booth can be replaced with a movable or temporary screen or the like. Accordingly, the present booth as shown should not limit the scope of the claims herein. One of ordinary skill in the art would recognize other variations, modifications, and alternatives.

II. Present Methods and Computer Programs

A. Overall Flow Diagram and Method

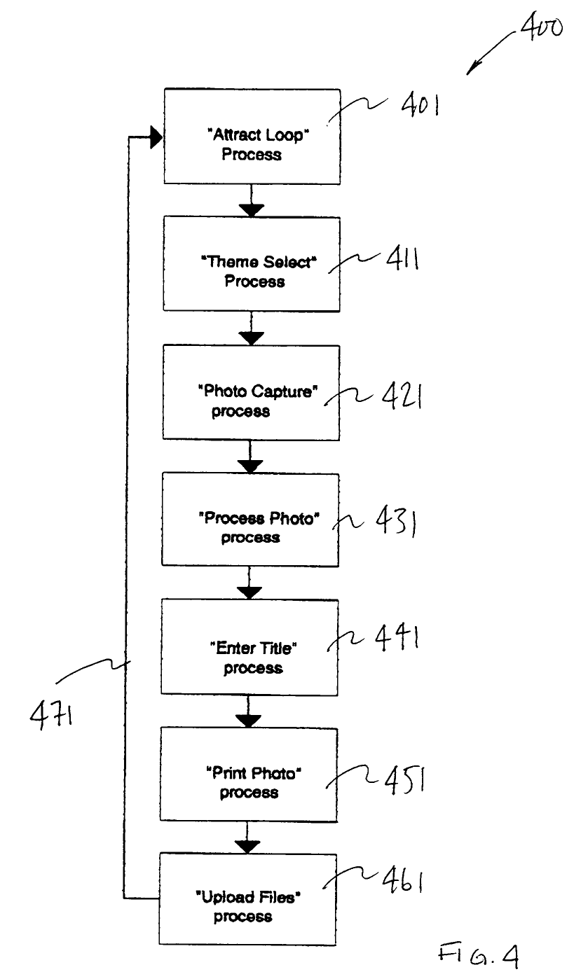

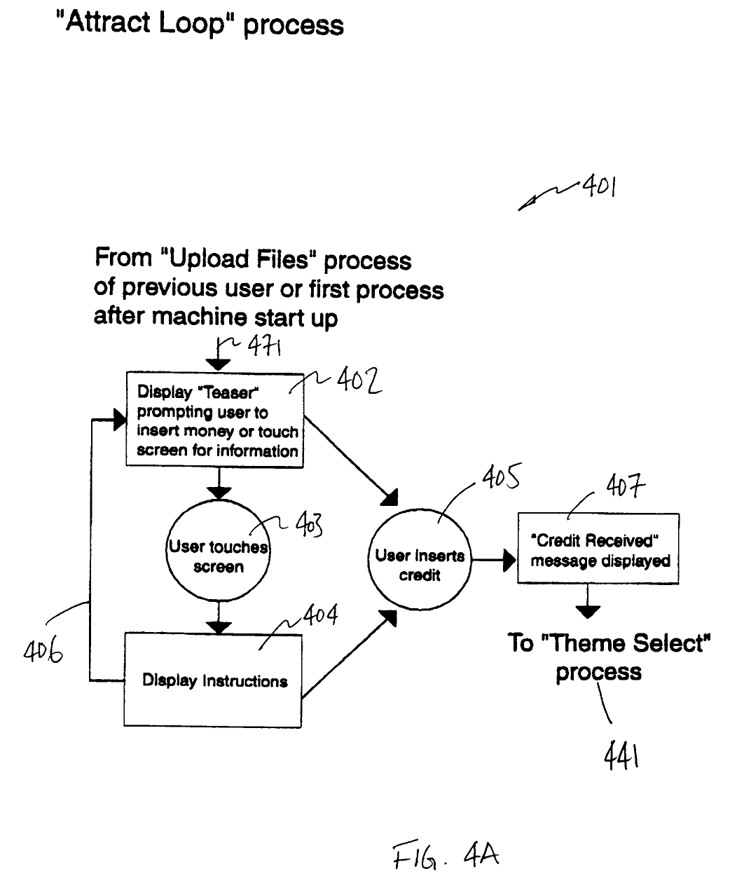

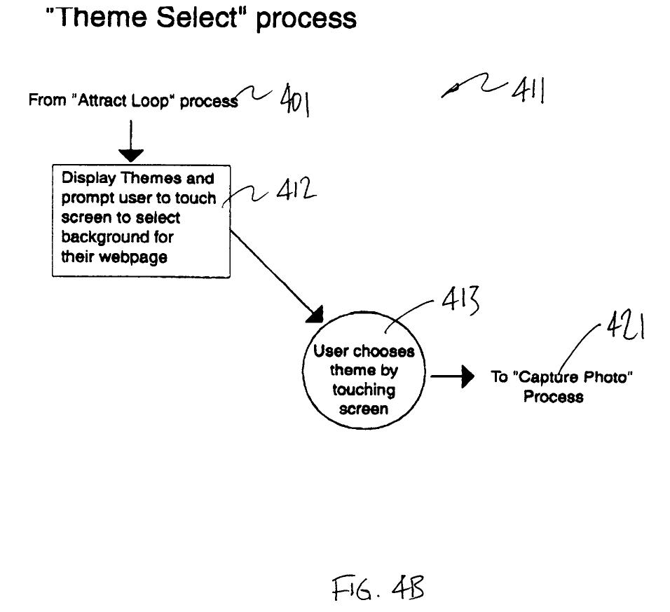

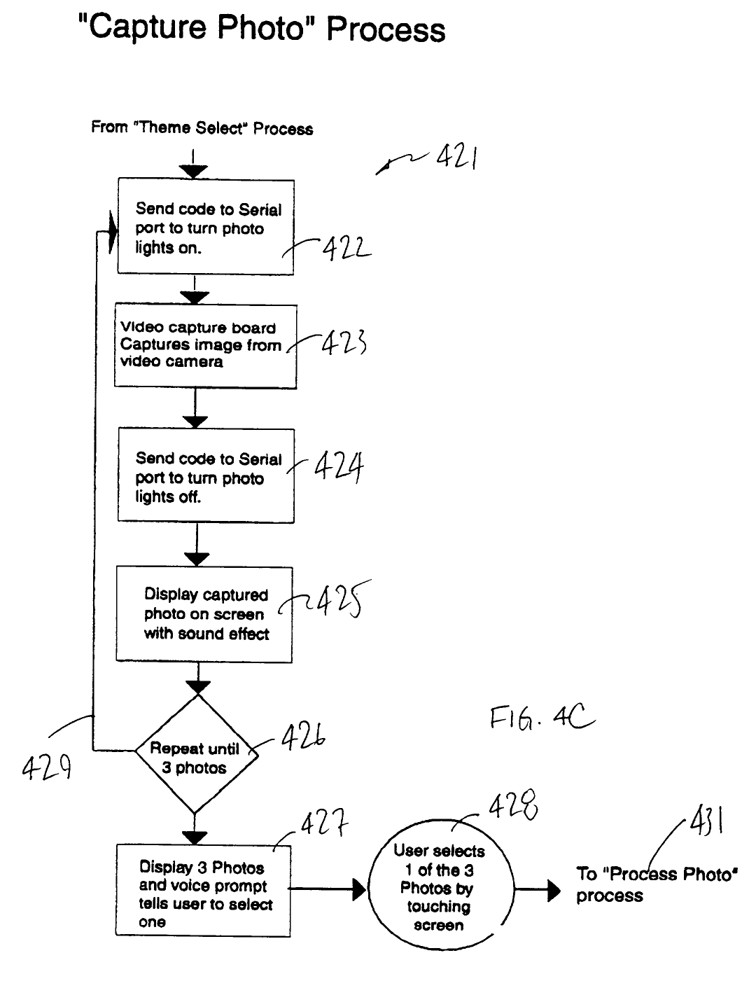

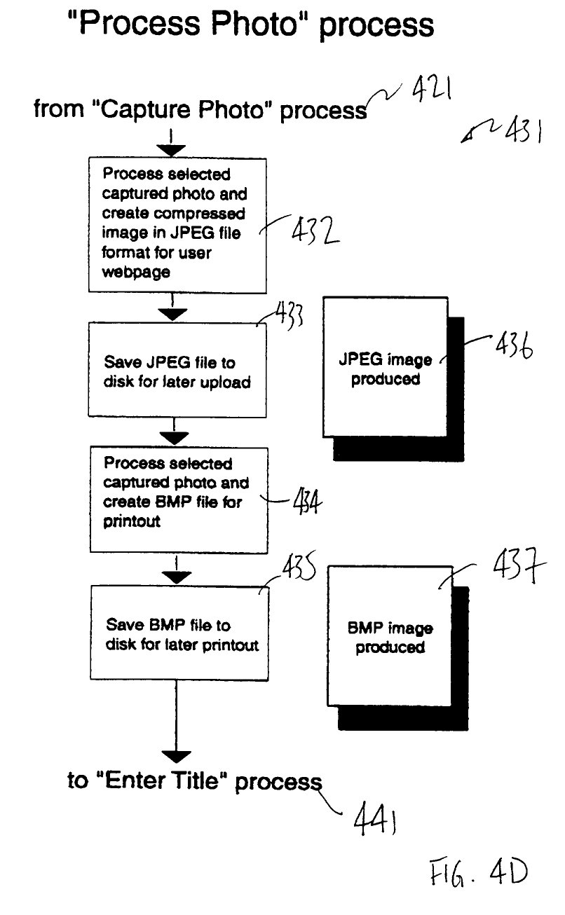

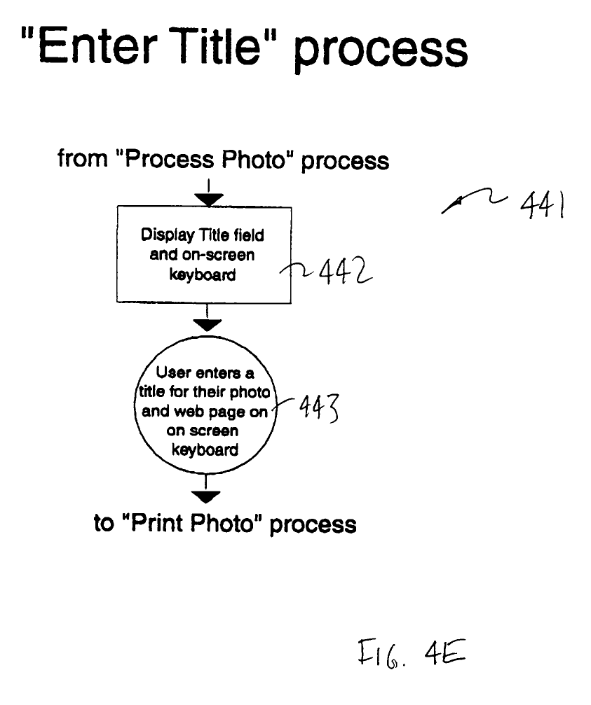

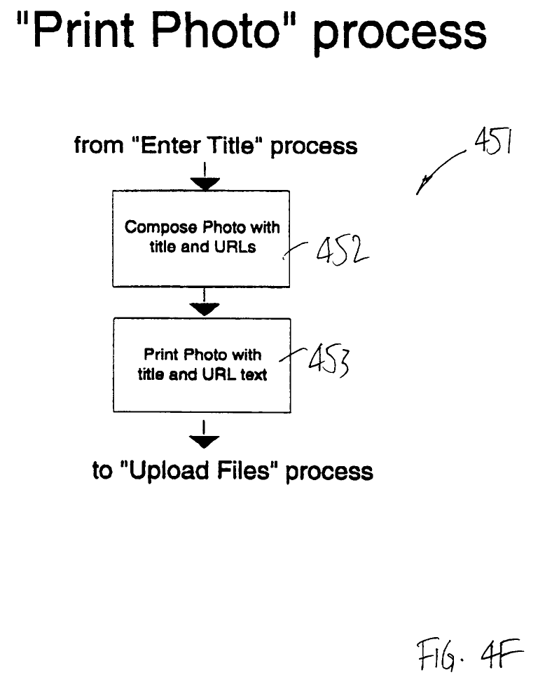

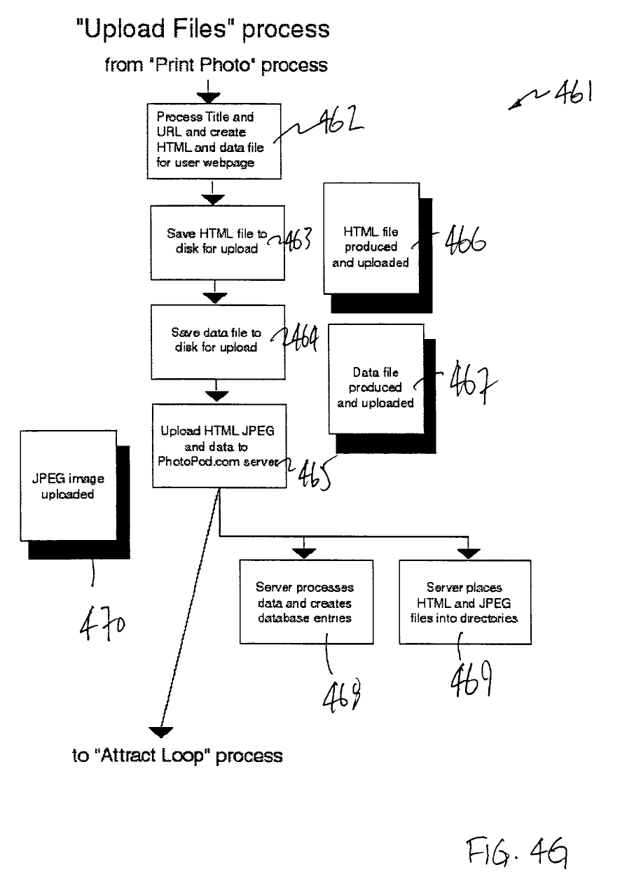

FIG. 4 is a simplified flow diagram 400 of a general method according to an embodiment of the present invention. The flow diagram is merely and illustration and should not limit the scope of the claims herein. One of ordinary skill in the art would recognize other variations, alternatives, and modifications. The method can be implemented by way of computer software and/or hardware. The flow diagram 400 includes a variety of steps. The steps begin with one or more modules or process steps, which will be described in more detail below, but will be generally described as follows. In a specific embodiment, the present method uses an attract loop to lure or attract a user or users (i.e., customers) to a booth, such as the one in the above FIGS. The attract loop (step 401) uses a monitor that outputs or displays a video and/or audio program, also called a “teaser,” to demonstrate an operation and/or benefits of the present booth. The user approaches the booth, and if successful, steps inside the booth or in front of the interior display monitor. In some embodiments, the user also sits down on the bench inside the booth before carrying out the methods described herein as well as others.

Once inside the booth, the user selects a “theme” using a theme select process, step 411, according to a specific embodiment. In particular, the user sits in front of a user interface such as a touch screen on the display. The touch screen display prompts the user to insert a vending card or alike, which has been purchased from a venue owner. Alternatively, money such as bills or coins or tokens can be used. The user inserts the card. The touch screen displays a second montage, culminating in a screen which asks the user to choose a background theme or a selected number of background themes. The user selects a background theme by way of the touch screen.

In a specific embodiment, the method then captures the user's image in digital form, step 421. In a specific embodiment, the method captures one or more than one, such as three or more images, from the user. The images can be captured in combination with light bulb flashes, which are used to illuminate the user. Alternatively, the light bulb flashes can also provide a signal or indication to the user upon completion of the capturing process. The image of the user and background form the picture. The picture is displayed on the screen for user viewing. The user selects one or more of the pictures, which are provided on one or more themes or backgrounds. Selection occurs by way of the touch screen.

A process photo process (step 431) is performed according to a specific embodiment. The photo process step uses image processing techniques to convert the picture into a usable graphical or information format. In a specific embodiment, the photo process converts the picture into a usable format such as a JPEG file for a web page on the world wide web or internet. The present process also converts the picture into a bitmap file or picture (i.e., BMP) for outputting onto a hard copy. Accordingly, the selected image is converted into a web page file or a hard copy.

A title can be selected for the picture, as shown in step 441, according to an embodiment. Here, the user decides upon a title and enters a title for his/her picture using an alphanumeric display or keyboard displayed on the touch screen. Alternatively, the user may use a different interface device such as a standard keyboard for entering the title and other alphanumeric information.

In a specific embodiment, the present method uses a print photo process, step 451. The print photo process composes the picture into a photo along with the title and a selected address or Uniform Resource Location, e.g., URL. That is, the URL is created for the user. Additional information includes, among others, title, time, and location of booth such as venue, where the image has been acquired. Next, the process prints the picture with title and the URL text. The process also prints out a hard copy of the picture using, for example, a color printer or other output device. The picture can include a variety of features such as the title, the name of the venue where the booth is located, the background, address (e.g., URL), and other elements. The picture can also be in the form of stickers, which are multiple pictures. Alternatively, the picture can be in the form of a postcard or the like.

In a specific embodiment, the method also has a step of uploading (step 461) the information as one or more files. The uploading process converts the title, URL, and other information into universal formats including, for example, hypertext markup language (i.e., HTML) and a data file. The HTML file is permanently or temporarily stored onto a memory device such as a hard disk, which holds the HTML file. The data file is also stored in the memory device or other memory storage media. The HTML, JPEG, and data file are uploaded onto, for example, a server or multiple servers. As merely an example, the server is a central server such as, for example, “PhotoPod.com server,” but can be others. The server categorizes the files in specific locations or in a data base. The server is coupled to a wide area network of computers such as the internet, as well as other like networks.

The method returns from step 461 to the attract loop 401 process by way of branch 471. The flow diagram above merely shows a generalized sequence of steps according to an embodiment of the present invention. The flow diagram can also include additional steps. Additionally, the sequence of steps can be altered depending upon the application. Furthermore, the steps can be further combined or even separated depending upon the application. Selected details with regard to each of the steps, noted above, are show in references to the FIGS. below.

Although the booth utilizes a video camera in a specific embodiment, alternative embodiments would include capturing video rather than stills from the users or customers. These live videos would be available for manipulation. The captured video would be uploaded to the web page and/or transferred onto a VHS tape or digital video disco or some other physical medium available in the booth or other location. The image capture device could also be located in a kiosk or another publicly located space other than a booth. Additionally, the present booth can use an ink jet printer or any other kind or high speed photographic quality color printer could be used instead of a dye sublimation printer. In some embodiments, the present vending card reader could be replaced by a bill, coin, or token acceptor or a credit card or debit card reader. Furthermore, the present network connection cable could be replaced by a cable leading to a modem and a telephone.

Accordingly, the present flow diagrams above merely show a generalized sequence of steps according to one or more embodiments of the present invention. The flow diagrams can also include additional steps as well as use other hardware elements. Additionally, the sequence of steps can be altered depending upon the application. Furthermore, the steps can be further combined or even separated depending upon the application. Selected details with regard to each of the steps, noted above, are show in references to the FIGS. below.

B. Detailed Flow Diagrams and Methods

1. Attract Loop Flow Diagram

FIG. 4A (entitled “Attract Loop”) is a simplified flow diagram 401 of an attract loop according to an embodiment of the present invention. In a specific embodiment, the present method uses an attract loop to lure or attract a user or users (i.e., customers) to a booth, such as the one in the above FIGS. The attract loop (step 401) uses a monitor that outputs or displays (step 402) a video and/or audio program, also called a “teaser,” to demonstrate an operation and/or benefits of the present booth. The user approaches the booth, and if successful, steps inside the booth or in front of the interior display monitor. In some embodiments, the users also sit down on the bench inside the booth. The user touches (step 403) to begin the method or process. The display outputs instructions (step 404) onto the screen of monitor. The user inserts credit (step 405) into the receptacle. Once the credit is received, a “credit received” message is displayed, step 407. The method proceeds to the theme select process, step 441. Alternatively, the user does not insert a credit and the method returns via branch 406 to step 402, which attempts to attract another potential user or customer.

2. Attract Loop Computer Codes

In a specific embodiment, the attract loop can be in implemented in code of a computer program written in Macromedia Director. It displays a video montage of the use and operation of the present booth. The present computer program has been written in Macromedia Director, but can also written in a variety of other programs. An example of a program listing is shown below.

Attract Loop: global helpList, helpCounter, nextMovie

on startMovie

startTimer

set nextMovie=FALSE

set helpCounter=1

set helpList=[31,32,33,34,-99] end

on keyDown

if nextMovie=FALSE then

if (the key=4) or (the key=“g”) then

puppetSprite 14, FALSE

puppetSprite 15, FALSE

puppetSprite 16, FALSE

set nextMovie=TRUE

go to frame “ThankYou”

end if

end if end

on exitMovie

go to frame 1 of movie “background” end on enterFrame

set the volume of sound 2 to 100 end on exitFrame

go to frame “External Loop” end on exitFrame

startTimer

go to frame “Help Prompt” end global helpCounter

on enterFrame

set helpCounter=1 end

on exitFrame

if the timer<300 then

go to the frame

else

startTimer

go to frame “external loop”

end if end on enterFrame

puppetSprite 14, TRUE

puppetSprite 15, TRUE

puppetSprite 16, TRUE end

on exitFrame puppetSprite 14, FALSE

puppetSprite 15, FALSE

puppetSprite 16, FALSE

go to frame “Insert” end on exitFrame

startTimer

repeat while the timer<200

nothing

end repeat

set nextMovie=FALSE end on enterFrame

set the volume of sound 2 to 200 end on exitFrame

exitMovie end global helpList, helpCounter

on mouseDown

set the memberNum of sprite 14 to 9

updatestage

waitForit

set the memberNum of sprite 14 to 10

updateStage

waitForit

waitForlt

set the memberNum of sprite 14 to 9

updateStage

waitForit

set the memberNum of sprite 14 to 8

updateStage

pageup end

on waitForit

starttimer

repeat while the timer<3

nothing

end repeat end

on pageup

set helpCounter=helpCounter−1

set heIpPage=getAt(helpList, helpCounter)

set the memberNum of sprite 16=helpPage

updateStage

if helpCounter=1 then

turnOffButton

end if

if helpCounter=3 then

turnOnButton

end if end

on turnOffButton

if the member of sprite 14=member “buttonup1” then

set the member of sprite 14 to member “cover5”

updateStage

waitForit

set the member of sprite 14 to member “cover4”

update Stage

waitForit

set the member of sprite 14 to member “cover3”

updateStage

waitForit

set the member of sprite 14 to member “cover2”

updateStage

waitForit

set the member of sprite 14 to member “cover1”

updateStage

end if end

on turnOnButton if the member of sprite 15=member “cover” then

set the member of sprite 15 to member “cover2”

updateStage

waitForit

set the member of sprite 15 to member “cover3”

updateStage

waitForit

set the member of sprite 15 to member “cover4”

updateStage

waitForit

set the member of sprite 15 to member “cover5”

updateStage

waitForit

set the member of sprite 15 to member “buttondown1”

update Stage

end if end global helpList, helpCounter

on mouseDown

set the member of sprite 15 to member “buttondown2”

updateStage

waitForit

set the member of sprite 15 to member “buttondown3”

updateStage

waitForit

waitForit

set the member of sprite 15 to member “buttondown2”

updateStage waitForit

set the member of sprite 15 to member “buttondown1”

updateStage

pageDown end

on waitForit

startTimer

repeat while the timer<3

nothing

end repeat end

on pageDown

set helpCounter=helpCounter+1

set heippage=getAt(helpList, helpCounter)

set the memberNum of sprite 16=heippage

updateStage

if helpCounter=2 then

turnOnButton

end if

if helpCounter=4 then

turnOffButton

end if end

on turnOffButton

if the member of sprite 15 member “buttondown1” then

set the member of sprite 15 to member “cover5”

updateStage

waitForit

set the member of sprite 15 to member “cover4”

updatestage

waitForit

set the member of sprite 15 to member “cover3”

updatestage

waitForit

set the member of sprite 15 to member “cover2”

updatestage

waitForit

set the member of sprite 15 to member “cover1”

updateStage

end if end

on turnOnButton if the member of sprite 14=member “cover” then

set the member of sprite 14 to member “cover2”

updateStage

waitForit set the member of sprite 14 to member “cover3”

updateStage

waitForit

set the member of sprite 14 to member “cover4”

updatestage

waitForit

set the member of sprite 14 to member “cover5”

updateStage

waitForit

set the member of sprite 14 to member “buttonup1”

updatestage

end if end on mouseDown

set the memberNum of sprite 12 to 15

updatestage

waitForit

set the memberNum of sprite 12 to 16

updateStage

waitForit

waitForit

set the memberNum of sprite 12 to 15

updateStage

waitForit

set the memberNum of sprite 12 to 14

updateStage

go to frame “help” end

on waitForit

startTimer

repeat while the timer<3

nothing

end repeat end on mouseDown

set the memberNum of sprite 13 to 18

updateStage

waitForit

set the memberNum of sprite 13 to 19

updatestage

waitForit

waitForit

set the memberNum of sprite 13 to 18

updatestage

waitForit

set the memberNum of sprite 13 to 17

updatestage

starttimer

go to frame “Insert” endon waitForit

startTimer

repeat while the timer<3

nothing

end repeat end on mouseup

go to frame “Internal Loop” end on mouseDown

set the member of sprite 17 to member “exithelp2”

updateStage

waitForit

set the member of sprite 17 to member “exithelp3”

updateStage

waitForit

set the member of sprite 17 to member “exithelp2”

updateStage

waitForit

set the member of sprite 17 to member “exithelp1”

updateStage

puppetSprite 14, FALSE

puppetSprite 15, FALSE

puppetSprite 16, FALSE

go to frame “Insert” end

on waitForit

startTimer

repeat while the timer<3

nothing

end repeat end

The above computer code is merely an example of one way to implement the present invention. The computer code is not intended to be limiting the scope of the claims herein in any manner. One of ordinary skill in the art would recognize other variations, modifications, and alternatives.

1. Theme Select Flow Diagram

FIG. 4B (entitled “Theme Select”) is a simplified flow diagram of a theme select process according to an embodiment of the present invention. Once inside the booth, the user selects a “theme” using a theme select process, step 411, according to a specific embodiment. As previously noted, the user sits in front of a user interface such as a touch screen on the display. The touch screen display prompts the user to insert a vending card or alike, which has been purchased from a venue owner. Alternatively, money such as bills or coins can be used. The user inserts the card. The touch screen displays (step 412) a second montage, culminating in a screen which asks the user to choose a background theme or a selected number of background themes. The user selects (step 413) a background theme by way of the touch screen. The method goes to the next step, which is the capture photo process, but can be others.

2. Theme Select Computer Codes

In a specific embodiment, the present theme select process is implemented as code of a computer program, which is called “background.” The present computer program has been written in Macromedia Director, but can also written in a variety of other programs. The present process enables customers or users to choose a background to be placed behind or in front of their image. An example of a program listing is shown below.

background: global gCommPort, slaveOff

on writeFile

put FilelO(mNew,“write”, the pathname & “composite.txt”) into writeObj

set filetext=field “info”

writeObj(mWriteString, fileText)

writeObj(mDispose) end

on initCommport

openXlib (the pathname & “commport”)

if objectP(gCommPort) then gCommPort(mDispose)

put commport(mNew,“com4”, 10000,10000) into gCommPort

gCommPort(mSetUp,2400,10,0) end

on extMonitorOff

setOffText

gCommPort(mWriteFlush)

gCommPort(mWriteString,slaveOff)

gCommPort(mWriteString,slaveOff) end

on setOffText

put field “slaveOffField” into slaveOff end

on disableCommport

if objectP(gCommPort) then gCommPort(mDispose) end

On exitMovie

disableCommport

go to frame 1 of movie “capture” end on enterFrame

if the timer>2000 then

put “bgr008.bmp” into line 1 of field 16

put “tile08.gif” into line 2 of field 16

put “ban008.bmp” into line 3 of field 16

put “#000000” into line 4 of field 16—Text Color

put “#660066” into line 5 of field 16—Link Color

put “#80FFFF” into line 6 of field 16—Text color 2

put “R0 G0 B215” into line 7 of field 16—Print Font Color

writeFile

exitMovie

end if end

on exitFrame

go to the frame end

The above computer code is merely an example of one way to implement the present invention. The computer code is not intended to be limiting the scope of the claims herein in any manner. One of ordinary skill in the art would recognize other variations, modifications, and alternatives.

1. Photo Capture Flow Diagram

FIG. 4C (entitled “Photo Capture”) is a simplified flow diagram 421 of a photo capture process according to an embodiment of the present invention. In a specific embodiment, the method then captures the user's image in digital form, step 421. In a specific embodiment, the method captures one or more than one, such as three or more images, from the user. In particular, the method sends via a processing unit a signal to a serial port to turn photo lights on, step 422. The images can be captured in combination with light bulb flashes, which are used to illuminate the user. Alternatively, the light bulb flashes can also provide a signal or indication to the user upon completion of the capturing process. The image of the user and background form the picture, which is captured by a camera, step 423. The camera is driven by a video capture board or the like. The picture is displayed (step 425) on the screen for user viewing. In some embodiments, the picture display also occurs with sound or other special influences. The process is repeated, step 426, for a selected number of times via branch 429. Once the desired number of processes are repeated, the selected number (e.g., three) of pictures are displayed on the monitor for viewing. The user selects (step 428) one or more of the pictures, which are provided on one or more themes or backgrounds. Selection occurs by way of the touch screen. The method goes to the process photo process (step 431), but is not limited to this process.

2. Photo Capture Computer Codes

In a specific embodiment, the present capture process includes at least three parts, which have been referenced in this manner for reading convenience, but is not limited to these three parts. The first is the code of a computer program written in Macromedia Director which helps enable the computer to capture an image from the camera and the Snappy image capture device. The second is a description of a program written in C++ (an “Xtra”) which helps integrate the image capture into the rest of the sequence performed by the booth. The third is the code of a program written in Macromedia Director which enables the customer to choose which of the three photographs they like best.

Part One (Written in Macromedia Director)

global captureNum, CountDown, captureList, gCommPort

on enterFrame

put 5 into field “numberField”

set captureNum=0

set CountDown=6

set captureList=[“photo1.bmp”,“photo2.bmp”,“photo3.bmp”]

put “Snapping your photo in . . . ” into field “messageField”

if not xtraLoaded(“Snappy”) then

if not fileExists(the pathName & “Snappy.X32”) then

if not fileExists(the pathName & “Xtras\Snappy.x32”) then

go to frame “No Snappy Xtra”

return

else

openxlib the pathName & “Xtras\Snappy.x32”

end if

else

openxlib the pathName & “Snappy.x32”

end if

if not xtraLoaded(“Snappy”) then

go to frame “Bad Snappy open”

return

end if

end if

initializeSnappy

SetCameraNotTape(TRUE)

SetSVideoNotComposite(FALSE)

SetTermination(TRUE)

SetSlowFineNotFastRough(TRUE)

SetSnapMode(1)—Moving

SetPictureSize(800,600)

SetBrightness(0)

SetContrast(0)

initCommport end

on fileExists theFile

set thePath to pathOnly(theFile)

if thePath=EMPTY then set thePath to the pathName

set fileName to fileOnly(theFile)

repeat with i=1 to the maxinteger

set thisFile to getNthFileNamelnFolder(thePath, i)

if thisFile=EMPTY then return FALSE if thisFile=fileName then

return TRUE

end repeat

return FALSE end

on fileOnly thePath

set oldDelim to the itemDelimiter

set the itemDelimiter to “:”

if the machineType>=256 then set the itemDelimiter to“\”

set ni to the number of items in thePath

set returnValue to item ni of thePath

set the itemDelimiter to oldDelim

return returnValue end

on xtraLoaded xtraName

set nx=the number of xtras

repeat with i=1 to nx

if the name of xtra i=xtraName then return true

end repeat

return FALSE end

on initializeSnappy

set err=InitSnappyo

if err=1 then

put “Snappy initialized” into field “messageField”

else

put “Error initializing Snappy” into field “messageField”

go to the frame “Bad Snappy Open”

end if end

on initCommport

openXlib (the pathname & “commport”)

if objectP(gCommPort) then gCommPort(mDispose)

put commport(mNew,“com4”,10000,10000) into gCommPort

gCommPort(mSetUp,2400,10,0) end

global captureNum, CountDown, gCommPort, msterOn,

On enterFrame

waitasec

set countDown=countDown−1

put countDown into field “numberField”

updatestage end

on waitasec startTimer

repeat While the timer<55

nothing

end repeat end

on exitFrame

if countDown=3 then puppetSound 3, “buildflash”

if countDown<=“0” then

if captureNum=0 then firstCapture

set captureNum=captureNum +1

turnOn

go to frame “Flash”

else

go to the frame

end if end

on tumOn

setOnText

gCommPort(mWriteFlush)

gCommPort(mWriteString,msterOn)

gCommPort(mWriteString,msterOn) end

on setOnText

put field “msterOnField” into msterOn end

on firstCapture

set the fileName of member “processing” to the pathName & “processing.bmp”

—set the registration point to be the center

set the regPoint of member “processing” to point?

(((the left of the rect of member “processing”)?

+(the right of the rect of member “processing”))/2,?

((the top of the rect of member “processing”)?

+(the bottom of the rect of member “processing”))/2) end global

msteroff

On enterFrame

snappicture( )

pause end

on idle

put snappyStatus( ) into field “MessageField”

updatestage—if snappyStatuso=“Acquiring: 0%” then turnOff

if snappyStatuso=“Snappy Data Ready” then

turnOff

continue

end if end

on turnOff

setOffText

gCommPort(mWriteFlush)

gCommPort(mWriteString,msterOff)

gCommPort(mWriteString,msterOff) end

on setOffText

put field “msterOffField” into msterOff end global captureNum,

CountDown

on enterFrame

reactionSounds

resetCounter end

on reactionSounds

—play reaction sounds

if captureNum=1 then

puppetSound 4, “hmmm”

end if

if captureNum=2 then

puppetSound 4, “laughl”

end if

if captureNum=3 then

puppetSound 4, “laugh2”

end if

updatestage end

on resetCounter

if captureNum<3 then

startTimer

repeat while the timer<180

nothing

end repeat

set countDown=6

set status=“Snapping your image in.”

put status into field “messageField”

puppetSound 4, “again”

startTimer

repeat while the timer<70

nothing end repeat

puppetSound 4, 0

go to frame “countdown”

else

starttimer

repeat while the timer<200

nothing

end repeat

end if end global captureNum, captureList

on enterFrame

getimage end

on getimage

set the fileName of member “processing” to the pathName & getAt(captureList, captureNum)

—set the registration point to be the center

set the regpoint of member “processing” to point?

(((the left of the rect of member “processing”)?

+(the right of the rect of member “processing”))/2,?

((the top of the rect of member “processing”)?

+(the bottom of the rect of member “processing”))/2) end

Part Two (“Snappy Xtra” program in C++)

This program is written in C++ and integrates the capture of the customer's image into the sequence of actions performed by the booth.

Part Three (Written in Macromedia Director)

global spriteNum

on tagimage

put FilelO(mNew,“write”, the pathname & “image.txt”) into writeObj

set fileText to field 14

writeObj(mWriteString, fileText)

writeObj(mDispose) end

on flashPhoto

puppetSprite spriteNum, TRUE

set the ink of sprite spriteNum=2

updateStage

startTimer

repeat while the timer<6

nothing

end repeat

set the ink of sprite spriteNum=0

updateStage

startTimer

repeat while the timer<60

nothing

end repeat end

on exitMovie

go to frame 1 of movie “jpeg” end global nbr, photoRegis

on enterFrame

startTimer

repeat while the timer<120

nothing

end repeat end

on exitFrame

set the fileName of member “photo1” to the pathname & “photo1.bmp”

set the fileName of member “photo2” to the pathName & “photo2.bmp”

set the fileName of member “photo3” to the pathname & “photo3.bmp”

setRegis end

on setRegis

repeat with nbr=3 down to 1

put “photo” & nbr into photoRegis—set the registration point to be the center

set the regPoint of member photoRegis to point?

(((the left of the rect of member photoRegis )?

+(the right of the rect of member photoRegis ))/2,?

((the top of the rect of member photoRegis )?

+(the bottom of the rect of member photoRegis ))/2)

end repeat end

The above computer code is merely an example of one way to implement the present invention. The computer code is not intended to be limiting the scope of the claims herein in any manner. One of ordinary skill in the art would recognize other variations, modifications, and alternatives.

1. Photo Process Flow Diagram

FIG. 4E (entitled “Process Photo Process”) shows a simplified flow diagram 431 of a photo processing method or process according to an embodiment of the present invention. By way of computer software and hardware, the present process photo process (step 431) is performed. The process photo process uses image processing techniques to convert the picture, which is captured from the CCD camera, into a usable graphical or information format. In a specific embodiment, the photo process converts (step 432) the picture into a JPEG file 436 for a web page on the World Wide Web, internet, or network of computers. The present process also converts (step 434) the picture into a bitmap file or picture (i.e., BMP) 437 for outputting onto a hard copy or the like. Accordingly, the selected image is converted into a web page file or a hard copy. The method goes to the enter title process, step 441, but is not limited to this process.

2. Photo Process Computer Codes

The present photo process is implemented by way of a computer software program which converts the captured images into a file and then makes that file ready to be placed or displayed on a wide area network of computers such as the World Wide Web or the like. This program has three parts. The first is the code of a program written in Macromedia Director which turns the captured image into a JPEG file. The second is a description of a commercially available program in C++ that comes bundled with Macromedia Director and is known as “Fileio.” Fileio helps create the web pages and keeps track of the pages through the use of serial numbers. The third is a description of a commercially available program (an “Xtra”) in C++known as “f3export” which takes the JPEG file and makes it ready for placement onto the world wide web.

Part One or JPEG (Written in Macromedia Director)

global imageprint, photoRegis

on enterFrame

getphoto end

on getPhoto

put FilelO(mNew,“read”, the pathname & “image.txt”) into readObj

put readObj(mReadfile) into imageprint

readObj(mDispose)

put char 1 to 10 of imageprint into imagePrint

set the fileName of member “selectedphoto” to the pathname &

imageprint

setRegis

set the visible of sprite 3=TRUE end

on setRegis

put “selectedphoto” into photoRegis

—set the registration point to be the center

set the regpoint of member photoRegis to point?

(((the left of the rect of member photoRegis )?

+(the right of the rect of member photoRegis ))/2,?

((the top of the rect of member photoRegis )?

+(the bottom of the rect of member photoRegis ))/2) end global image,

imagePrint, gcounter, identifier, fileText

on enterFrame

getldentifier

makeJPEG end

on getidentifier

—

—creates the identifier by reading the serial number, incrementing it,

—storing it in field “counterField”, then writing it back out to the file.

—

put filelo (mNew,“read”,the pathname & “counter.txt”) into readObj

put readObj(mReadFile) into field “counterField”

readObj(mDispose)

—

put integer(field “counterField”+1) into gcounter

—

put FilelO(mNew,“write”, the pathname & “counter.txt”) into writeObj

put string(gcounter) into fileText

writeObj(mWriteString, fileText)

writeObj(mDispose)—

set identifier=“vc−” & gCounter

set image=identifier & “.jpg” end

on makeJPEG

—set isOK=f3ExportPict(member “selectedPhoto”, identifier & “.jpg”)

—isOK holds text if there is an error

—if (isOK< >0) then put isOK—isOK is sent to the Message

Window

f3ExportJpeg(member “selectedPhoto”, image) end

on exitFrame

go to frame 1 of movie “writer” end

Part Two (Description of Fileio)

Fileio is a program written in C++ that is commerically available and comes bundled with Macromedia director It is integrated with the above program and helps to create the web pages and keeps track of the pages through the use of serial numbers.

Part Three (Description of f3export)

F3export is a commercially available program (an “Xtra”) in C++ which takes the JPEG file and makes it ready for placement onto the World Wide Web.

The above computer code is merely an example of one way to implement the present invention. The computer code is not intended to be limiting the scope of the claims herein in any manner. One of ordinary skill in the art would recognize other variations, modifications, and alternatives.

1. Title Process Flow Diagram

FIG. 4E is a simplified flow diagram of an enter title process or writer process according to an embodiment of the present invention. As shown, a title for the picture can be selected, as shown in step 441, according to an embodiment. Here, the user decides upon a title for the picture. The display shows (step 442) a title field and an on-screen keyboard, which has an alphanumeric set of keys. The user enters (step 443) a title for his/her picture using the alphanumeric display or keyboard displayed on the touch screen. Alternatively, the user may use a different interface device such as a standard keyboard for entering the title and other alphanumeric information. The method goes to a print photo process, but is not limited to this process.

2. Title Process Computer Codes

The title or writer process can be implemented into a computer program (entitled “Writer”) which enables the customer to create a title to add to their picture. The computer program can be prepared in Macromedia Director, as well as other types of formats. An example of a computer program is shown below.

global textEntered, charLength, keyNum, keySprite

on mouseDown

puppetSound 3 “Shutter2”

set podKey=“0”

set keyNum=1

set KeySprite=4

set charLength=charLength+1

set the member of sprite keySprite=43

set the ink of sprite keySprite=7

updateStage

if charLength<30 then set textEntered=textEntered & podKey

put textEntered into field “title”

resetKey end global textEntered, charLength, keyNum, keySprite

on startMovie

set the timeoutLength to 180*60

set the timeoutScript to “exitMovie”

set textEntered=“ ”

put textEntered into field “title”

—set the volume of sound 2 to 200

—puppetSound 2, “what ru call master”

—startTimer

—repeat while the timer<120

—nothing

—end repeat

—puppetSound 3, “please type title”

—startTimer

—repeat while the timer<150

—nothing

—end repeat

—puppetSound 4, “Hit the done”

set CharLength=0

set the wordWrap of member “title”=TRUE

startTimer end

on puppetEm

repeat with i=1 to 41

puppetsprite (i+3), TRUE

end repeat end

on resetKey set the member of sprite keySprite=keyNum

set the ink of sprite keySprite=0

updatestage end

on writeFile

put FilelO(mNew,“write”, the pathname & “title.txt”) into writeObj

set filetext=field “title”

writeObj(mWriteString, fileText)

writeObj(mDispose) end

on exitMovie

—writeFile

go to frame 1 of movie “email” end global textstring, textEntered

on mouseDown

puppetSound “Shutter2”

set the member of sprite 44=42

set the ink of sprite 44=7

updatestage

set the member of sprite 44=40

set the ink of sprite 44=0

updateStage

set textString=textEntered

—set textEntered=textEntered & “*”

put textEntered into field “title”

resetKey

exitMovie end

The above computer code is merely an example of one way to implement the present invention. The computer code is not intended to be limiting the scope of the claims herein in any manner. One of ordinary skill in the art would recognize other variations, modifications, and alternatives.

1. Print Process Flow Diagram

FIG. 4F (entitled “Print Photo”) is a simplified flow diagram 451 of a print photo process according to an embodiment of the present invention. In a specific embodiment, the present method uses a print photo process, step 451. The print photo process composes (step 452) the picture into a photo along with the title and a selected address or Uniform Resource Location, e.g., URL. That is, the URL is created for the user. Additional information includes, among others, title, time, and location of booth such as venue, where the image has been acquired. Next, the process prints (step 453) the picture with title and the URL text. The process also prints out a hard copy of the picture using, for example, a color printer or other an output device. The picture can include a variety of features such as the title, the name of the venue where the booth is located, the background, address (e.g., URL), and other elements. The picture can also be in the form of stickers, which are multiple pictures. Alternatively, the picture can be in the form of a postcard or the like. The method goes to the upload files process, but is not limited to such process.

2. Print Process Computer Codes

The present print process includes software which enables the photograph and its title and associated graphics to be printed out. It has two parts. The first part is the code of a program written in Macromedia Director. The second is a description of a commercially available program in C++ called “Print-O-Matic.” Together the two programs allow images to be printed with text and graphics. These codes or programs are merely examples and should not limit the scope of the claims herein.

Part One (Wriften in Macromedia Director)

global imageprint, VBan, textstring, theUrl, identifier, slaveOn,

gCommPort

—on startMovie —set textstring=“ ”

—end

on registerPOM

register (xtra “PrintOMatic”, “POMX153-467-02513”) end

on initCommport

openXlib (the pathname & “commport”)

if objectP(gCommPort) then gCommPort(mDispose)

put commport(mNew,“com4”,10000,10000) into gCommPort

gCommPort(mSetUp,2400,10,0) end

on extMonitorOn

setOnText

gCommPort(mWriteFlush)

gCommPort(mWriteString,slaveOn)

gCommPort(mWriteString,slaveOn) end

on setOnText

put field “slaveOnField” into slaveOn end

on disableCommport

if objectP(gCommPort) then gCommPort(mDispose) end

On exitMovie

extMonitorOn

disableCommport

go to frame 1 of movie “teaser” end

global imageprint, VBan, textstring, theUrl, identifier

on enterFrame

registerPOM

initCommPort

repeat with i=5 to 8

startTimer

repeat while the timer<80

set the memberNum of sprite 1 to i

updateStage end repeat

end repeat end

on assignment

put filelo (mNew,“read”,the pathname & “composite.txt”) into readObj

put readObj(mReadFile) into field “compositeField”

readObj(mDispose)

put filelo (mNew,“read”,the pathname & “image.txt”) into readObj

put readObj(mReadFile) into tempimage

readObj(mDispose)

—put filelo (mNew,“read”,the pathname & “title.txt”) into readObj

—put readObj(mReadFile) into tempstring

—readObj(mDispose)

—set charCounter=1

—put char charCounter of tempString into tempChar

—repeat while tempChar< >“*”

—set Z=textString & tempChar

—set charCounter=charCounter +1

—put char charcounter of tempString into tempChar

—end repeat

put char 1 to 10 of tempimage into imagePrint

put line 3 of field “compositeField” into VBan

put “http:/Iwww.photopod.com/vc/” & identifier & “.htm” into theUrl end

on printlt

set doc=new (xtra “PrintOMatic”)

if not objectp(doc) then

Alert “We're Sorry, there is no currently selected printer. Printing is not available at this time. Please contact staff.”

else

cursor 4

setMargins doc, Rect(16,28,1013,705)

setLandscapeMode doc, TRUE

setDocumentName doc,“PhotoPod Picture”

newPage doc

—assign the frame for the banner

newFrame doc, rect(0,0,284,213), FALSE

—put the banner

appendFile doc, the pathName & VBan, FALSE

—assign the frame for the photo

newFrame doc, rect(9,9,231,175), FALSE

—put the image

appendFile doc, the pathName & imageprint, FALSE

—set the type for title and URL

newFrame doc, rect(0, 184,222,213), FALSE

setTextLineSpacing doc, 0

setTextFont doc, “HandelGothic BT”

setTextStyle doc, “normal”

setTextJust doc, “center”

—colors were to be set according to background matrix

—but they are hard coded now

setColor doc, 203, 59,17

—put textstring

setTextSize doc, 9

append doc, textString, RETURN

—colors were to be set according to background matrix

—but they are hard coded now

setColor doc, 227,150, 13

—put theURL

setTextSize doc, 8

append doc, theURL, FALSE

setprogressloc doc, 641

print doc

—get rid of the document object

set doc=0

end if end

on exitFrame

assignment

printit end

Part Two (Description of Print-O-Matic)

Print-O-Matic is a commerically available program written in C++ which, when combined with the above program, enables the customer's image to be printed out onto a photograph along with text and graphics.

The above computer code is merely an example of one way to implement the present invention. The computer code is not intended to be limiting the scope of the claims herein in any manner. One of ordinary skill in the art would recognize other variations, modifications, and alternatives.

1. Upload Process Flow Diagram

FIG. 4G is a simplified flow diagram 461 of an upload files process according to an embodiment of the present invention. In a specific embodiment, the method also has a step of uploading (step 461) the information as files. The uploading process converts (step 462) the title, URL, and other information into universal formats including, for example, HTML and a data file. The HTML file is permanently or temporarily stored (step 463) onto a memory device such as a hard disk, which holds the HTML file 466. The data file is also stored (step 464) in the memory device or other memory. The HTML, JPEG 470, and data file are uploaded (step 465) onto, for example, a server or multiple servers. As merely an example, the server is a central server such as, for example, PhotoPod.com server, but can be others. The server categorizes the files in specific locations such as directories (step 469) and/or in a data base (step 468) as entries. The server is coupled to a wide area network of computers such as the internet, as well as other like networks. A user of the network of computers can access the server to view the image, including the title and other information, which has been captured at the booth.

2. Upload Process Computer Codes

The present upload process is implemented in part by a computer software program which creates a web address and transfers the image file to the web page, as shown below. It has two parts. The first part is the code of a program written in Macromedia Director, and the second part is a description of a commercially available program known as Mailsend.

Part One (Written in Macromedia Director)

global gcounter, count, identifier, textstring, image, linkColor, fontColor, webtile global datestring, date, month, day, year global time, timestring, hours, minutes, isPM

on enterFrame

getHTMLVars

getcount

getDateString

getDate

getTimeString

getTime

makeAttachTxt

makeAddTxt

makeldentTxt

makeHTML

email It end

on getHTMLVars

put filelo (mNew,“read”,the pathname & “composite.txt”) into readObj

put readObj(mReadFile) into field “HTMLVars Field”

readObj(m Dispose)

put line 5 of field “HTMLVars Field” into linkColor

put line 4 of field “HTMLVars Field” into fontColor

put line 2 of field “HTMLVars Field” into webtile end

on getcount

put gcounter into count end

on getDateString

put the long date into datestring end

on getDate

put the date into date

set the itemDelimiter=“/”

put value(item 1 of date) into month

put value(item 2 of date) into day

put value(item 3 of date) into year end

on getTimeString

put the time & “EST” into timeString end

on getTime put the time into time

set the itemDelimiter=“:”

put value(item 1 of time) into hours

put value(word 1 of item 2 of time) into minutes

put word 2 of item 2 of time into ampm

put (ampm=“PM”) into isPM end

on makeAttachTxt

put “−a” & identifier & “.jpg” into line 3 of field “attachText Field”

put “−a” & identifier & “.htm” into line 4 of field “attachText Field”

put FilelO(mNew,“write”, the pathname & “attach.txt”) into writeObj

set filetext=field “attachText Field” writeObj(mWriteString, fileText)

writeObj(mDispose) end

on makeAddTxt

put “−i” & identifier & “.txt” into line 5 of field “addtobody Field”

put FilelO(mNew,“write”, the pathname & “addtobody.txt”) into writeObj

set filetext=field “addtobody Field”

writeObj(mWriteString, fileText)

writeObj(mDispose) end

on makeldentTxt

put “identifie$” & identifier & “$@@” into line 1 of field 8

put “dat$” & date & “$@@” into line 2 of field 8

put “da$” & day & “$@@” into line 3 of field 8

put “mont$” & month & “$@@” into line 4 of field 8

put “yea$” & year & “$@@” into line 5 of field 8

put “text_strin$” & textstring & “$@@” into line 6 of field 8

put “po$vc$@@” into line 7 of field 8

put “podstrin$Virtua Cafe-Miami, Fla.$@@” into line 8 of field 8

put “ispm$” & isPM & “$@@” into line 9 of field 8

put “coun$” & count & “$@@” into line 10 of field 8

put “time_strin$” & timestring & “$@@” into line 11 of field 8

put “date_strin$” & dateString & “$@@” into line 12 of field 8

put “hou$” & hours & “$@@” into line 13 of field 8

put “minute$” & minutes & “$@@” into line 14 of field 8

put “webtil$” & webtile & “$@@” into line 15 of field 8

put FilelO(mNew,“write”, the pathname & identifier & “.txt”) into writeObj

set filetext=field 8

writeObj(mWriteString, fileText)

writeObj(mDispose) end

on makeHTML

duplicate member 11, member 9 put timestring after char 14 of line 4 of field 9

put datestring after char 12 of line 4 of field 9

put textString after char 10 of line 4 of field 9

put textString after char 37 of line 8 of field 9

put textstring after char 34 of line 9 of field 9

put date after char 30 of line 11 of field 9

put hours after char 30 of line 12 of field 9

put textString after char 37 of line 13 of field 9

put image after char 36 of line 14 of field 9

put webtile after char 77 of line 17 of field 9

put linkColor after char 47 of line 17 of field 9

put linkcolor after char 38 of line 17 of field 9

put fontColor after char 12 of line 17 of field 9

put textstring after char 46 of line 18 of field 9

put fontcolor after char 30 of line 18 of field 9

put image after char 18 of line 19 of field 9

put FilelO(mNew,“write”, the pathname & identifier & “.htm”) into

writeObj

set filetext=field 9

writeObj(mWriteString, fileText)

writeObj(mDispose) end

on emaillt

—run the MailSend program to attach the HTML and Image

—files to an e-mail message. It is minimized

open “start” & the pathname & “attach.lnk”

—run the MailSend program to add the variables to a mail message

—files to an e-mail message. It is minimized

open “start” & the pathname & “addtobod.Ink” end

on exitFrame

go to frame 1 of movie “print” end

Part Two (Decription of Mailsend)

Mailsend is a commercially available program written in C++. It is integrated with the above program, and together they work to mail the customer's image onto a page on the World Wide Web.

The above computer code is merely an example of one way to implement the present invention. The computer code is not intended to be limiting the scope of the claims herein in any manner. One of ordinary skill in the art would recognize other variations, modifications, and alternatives.

Although the above has been generally described in terms of hardware and software, it will be recognized that other variations can exist. As merely an example, the functionality of the present invention can be further combined, or even separated, in terms of hardware. Alternatively, the functionality of the present invention can be further combined, or even separated, in terms of computer software or programs. Furthermore, the functionality of the present invention can be further combined, or even separated, in terms of a combination of computer software or programs and hardware. Accordingly, the above descriptions in terms of hardware and software are not intended to limit the scope of the claims herein.

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A kiosk, said kiosk comprising:
a housing, said housing being a fully or partially enclosed structure;
an image capturing device coupled to said housing, said image capturing device being adapted to capture an image of a user;
a processing device, said processing device coupled to said image capturing device, said processing device converting said captured image into a plurality of signals;
a transmission device, said transmission device coupled to said processing device, said transmission device being adapted to transmit said plurality of signals; and
a wide area network of computers, said wide area network of computers being coupled to said transmission device to receive said plurality of signals.

2. The kiosk of claim 1 further comprising a display device, said display device being coupled to said processing device, said display device outputting said image of said user.

3. The kiosk of claim 2 wherein said display device is disposed on an interior portion of said housing.

4. The kiosk of claim 1 wherein further comprising a display device, said display device being coupled to said processing device, said display device outputting one or more images to attract said user to said kiosk.

5. The kiosk of claim 4 wherein said display device is disposed on an exterior portion of said housing.

6. The kiosk of claim 1 wherein said housing further comprises a bench.

7. The kiosk of claim 1 further comprising an input device, said input device being coupled to said processing device.

8. The kiosk of claim 1 further comprising a touch screen display device, said touch screen display device being coupled to said processing device.

9. The kiosk of claim 1 further comprising a server coupled to said wide area network of computers, said server being adapted to receive said plurality of signals.

10. The kiosk of claim 1 wherein at least one of said computers comprising said image of said user as a web site.

11. A kiosk of claim 1 wherein at least one of said computers comprising an e-mail address to receive said image of said user.

12. A public booth for transferring an image of a user over a wide area network of computers, said booth comprising:
an image capturing device coupled to said housing, said image capturing device being adapted to capture an image of a user;
a processing device, said processing device coupled to said image capturing device, said processing device converting said captured image into a plurality of signals;
a transmission device, said transmission device coupled to said processing device, said transmission device being adapted to transmit said plurality of signals.

13. The booth of claim 12 further comprising a display device being coupled to said processing device, said display device outputting said image of said user.

14. The booth of claim 12 further comprising an output device for providing a hard copy of said image to said user.

15. The booth of claim 12 further comprising a housing, said housing enclosing said image capturing device.

16. The booth of claim 12 further comprising a display device being coupled to said processing device.

17. The booth of claim 16 further comprising a graphical background on said display device.

18. The booth of claim 16 further comprising a display device being coupled to said processing device, said display device outputting one of a plurality of graphical backgrounds based upon an input of said user.

19. The booth of claim 12 further comprising an input device, said input device being selected from a keyboard or a touch screen.

20. A booth for capturing a photographic quality image of a user, said booth comprising:
a housing, said housing being a fully or partially enclosed structure;
an image capturing device coupled to said housing, said image capturing device being adapted to capture an image of a user;
a processing device, said processing device coupled to said image capturing device, said processing device converting said captured image into a plurality of signals;
a transmission device, said transmission device coupled to said processing device, said transmission device being adapted to transmit said plurality of signals;
a first display device for capturing said image from said user; and
a second display device for attracting said user to said booth.
